(19) United States
(12) Patent Application Publication
(10) Pub. No.: US 2011/0170564 A1
(43) Pub. Date: Jul. 14, 2011

(54) FIBER LASER OSCILLATORS AND SYSTEMS USING AN OPTIMIZED PHASE VARYING FUNCTION

(75) Inventors: Louis DESBIENS, St-Augustin-de-Desmaures (CA); Vincent Roy, Quebec (CA); Pascal Deladurantaye, St-Joseph de la Pointe-Levy (CA); Marco Michele Sisto, Quebec (CA); Yves Taillon, St-Augustin-de-Desmaures (CA); Brian W. Baird, Portland, OR (US)

(73) Assignee: Institut National D'Optique, Quebec (CA)

(21) Appl. No.: 12/974,509

(22) Filed: Dec. 21, 2010

Related U.S. Application Data
(60) Provisional application No. 61/288,784, filed on Dec. 21, 2009.

(51) Int. Cl. H01S 3/30

(52) U.S. Cl. 372/6

(57) ABSTRACT

A pulsed fiber laser oscillator and laser systems incorporating such laser oscillators are presented. The laser oscillator first includes a light generating module which generates optical pulses having an initial spectral profile. A spectrum tailoring module tailors the initial spectral profile of the optical pulses by imposing a phase variation on each optical pulse according to an optimized phase varying function. The optimized phase varying function has one of a rectified sinusoidal shape, a parabolic shape and a rectified parabolic shape. Laser systems incorporating such oscillators may be of a MOPA configuration, and may further include a nonlinear crystal for frequency conversion or a bulk solid-state amplifier.

This application claims benefit of Ser. No. 61/288,784, filed 21 Dec. 2009 in the United States and which application is incorporated herein by reference. To the extent appropriate, a claim of priority is made to each of the above disclosed applications.

### FIELD OF THE INVENTION

The present invention relates to the field of pulsed fiber lasers and more particularly concerns methods and systems tailoring the spectral profile of optical pulses using an optimized phase varying function to improve beam quality.

### BACKGROUND

Active optical fiber is the gain medium of choice for high power applications, as it is both efficient and robust. Such fibers are particularly useful in a Master Oscillator Power Amplifier (MOPA) architecture, which provides a versatile pulse generation scheme. However, pulsed operation of a MOPA system based on active optical fibers is limited by the onset of nonlinear effects. Those effects result from the guided propagation of high-peak power signals over long segments of optical fiber.

In the nanosecond regime, the first nonlinear effects encountered with an increase of optical power are the stimulated Brillouin Scattering (SBS) and self-phase modulation (SPM).

In SBS, the amplified signal generated by the system serves as a pump for a Stokes wave which is counter-propagating. This limits the possible amplification of the signal and the Stokes wave can possibly be destructive for upstream optical components.

The gain associated with SBS depends on the peak spectral density of the signal, the pulse duration and the effective area of the active fiber.

SPM arises from the nonlinear index of refraction associated with the propagation of high peak-power pulses in optical fibers. A temporal phase which is peak-power dependent is superimposed on the optical pulses. This phase does not degrade the temporal shape of the pulses as long as no wavelength selective elements are present in the optical path; however, it generates new spectral frequencies and consequently broadens the spectrum of the signal. SPM depends on the peak power of the pulses, on their temporal shape and on the effective area of the fiber. The rate at which a partially coherent signal will spectrally broaden in an amplifier is also dependent on the initial spectral width (see U.S. patent application published under no. 2010/0128744 by DELADURANTAYE et al).

is Applications such as laser micromachining can benefit from high beam quality since smaller, diffraction-limited spot sizes are achievable in this manner. This certainly limits the effective area of the doped fiber that can be used since high-order modes in multimode optical fibers degrade the achievable beam quality factor (M²), induce astigmatism, induce asymmetry and affect the beam pointing stability (see S. Wielandy “Implications of higher-order mode content in large mode area fibers with good beam quality” Opt. Express 15, 15402-15409 (2007)).

Micro-machining applications can also benefit from a frequency converted laser beam obtained through processes such as Second Harmonic Generation (SHG) and Sum-Frequency Generation (SFG), since the optical absorption of the material and the achievable spot size vary with the laser wavelength. Frequency conversion is a nonlinear process in which photons of a given energy interact to generate new photons with different energies. The simplest and industrially very important frequency conversion process is second harmonic generation in which two photons at a given fundamental wavelength interact in a nonlinear crystal to be converted to one photon at twice the energy, and therefore half the wavelength. One example of SHG is the conversion of two photons at a wavelength of 1064 nm to one photon at 532 nm. Nonlinear interactions in nonlinear crystals are typically very spectrally sensitive. For example, the spectral acceptance bandwidth for second harmonic generation is a function of the nonlinear crystal length and fundamental wavelength. A laser signal with a broad spectral content, that is, larger than the acceptance bandwidth of the crystal, will not be efficiently frequency converted.

Fiber based MOPA systems may also be employed as a seed source for bulk, solid-state amplifiers to achieve very high pulse energy. This technique has been employed by several workers. Baird et al. “Tandem photonic amplifier employing a pulsed is master oscillator fiber power amplifier with programmable temporal pulse shape capability”, Proc. SPIE, Vol. 6871, 68712A (2008), reported on the development of a 1064 nm pulsed Master Oscillator Fiber Power Amplifier (MOFPA) with integrated modulators enabling programmable temporal pulse shapes and its use in a tandem photonic amplifier. The MOFPA amplifier chain was seeded by a laser diode operated in CW (continuous wave) regime and yielded very stable spectral characteristics that were independent of the pulse repetition rate and pulse shape. Integrated LiNbO₃ electro-optic modulators operating in conjunction with high speed digital electronics provided pulse shaping capability and high repetition rate operation (100 kHz to 1 MHz) with fast rise times (<1 ns). In the tandem amplifier configuration, the MOFPA output was sent to a single-stage, single-pass Nd:YVO₄ amplifier pumped by a single 30 W fiber-coupled 808 nm diode laser. An incident average power of 600 mW with a pulse repetition rate of 100 kHz from the MOFPA was amplified to 6 W with faithful amplification of the input temporal pulse profile while achieving excellent beam quality and pulse amplitude stability.

In another work, Starodoumov et al. (“Hybrid fiber MOPA-bulk amplifier system for frequency conversion”, Proc. SPIE, Vol. 6871, pp. 68710V (2008)) reported on a hybrid fiber MOPA and solid-state amplifier for frequency conversion. Starodoumov employed a master oscillator fiber power amplifier to obtain pulsewidths in the range of 15-30 ns and an output average power above 20 W. Coupling into a bulk Nd:YVO₄ amplifier, Starodoumov obtained more than 65 W at pulse repetition rates of 300-500 kHz, and more than 35 W of green and 20 W of UV light after frequency conversion in appropriate nonlinear crystals.

Because of their crystalline nature (as opposed to the amorphous nature of glasses), solid-state gain media typically have narrow gain spectral bands. For example, Peng et. al. (“355 nm tailored pulse tandem amplifier”, Advanced-solid-state Photonics (ASSP) 2008, paper MC35) teaches the importance of careful spectral matching of a pulsed MOFPA signal input to a solid-state gain medium, such as Nd:YVO₄.

As those skilled in the art will appreciate, it is important in such applications to provide a mechanism for fine tuning the pulsed MOFPA spectral output to accommodate operational variations in the spectral emission bandwidth of the solid-state gain medium. For example, it was observed by Frede and co-workers (“Fundamental mode, single-frequency laser amplifier for gravitational wave detectors”, Opt. Express 15, 459-465 (2007)) and by Peng et al. (see reference above) that the center spontaneous emission wavelength of a Nd:YVO₄ crystal will experience a shift towards longer wavelengths as the pump power absorbed by the crystal increases. Therefore, achieving efficient and stable amplification of fiber based MOPA seed signal input from a neodymium-doped yttrium vanadate amplifier will require a seed with an appropriately narrow spectral content. Further, the narrow spectral content must be temporally stable. It is further highly desirable that the stable and narrow spectral content be tunable in order to match variations in the amplifier gain spectrum, caused either by operational effects or material variations from piece to piece, lot to lot, or manufacturer to manufacturer. It is also highly desirable to provide a method for programmable tunability of stable and narrow spectral content and further to provide a detection and feedback mechanism that allows for automatic tunability of spectral matching, for example when operational conditions are varied.

DELADURANTAYE et al (U.S. patent application published under no. 2010/0128744) teach methods based on phase variation techniques applied to narrow-linewidth sources to provide several advantages for pulsed MOPA configurations based on active optical fibers. Imposing a phase variation on optical pulses will generate spectral sidebands. The generation of sidebands distributes the pulse energy spectrally, which increases the SBS threshold without increasing the rate at which SPM will broaden the spectrum, since every sideband is broadened independently according to its linewidth. The generation of sidebands through phase variation does not increase the amplitude noise of the source since a fixed phase relation exists between the generated sidebands. However, spectral filtering with a wavelength selective element of a phase-modulated source can have a detrimental effect on its temporal amplitude stability. Phase variation modifies the instantaneous frequency throughout the pulse temporal profile. Removing spectral components through spectral filtering will alter locally the temporal profile of the pulse. Phase modulated signals may also suffer from reduced harmonic conversion efficiency. Further, the pulse amplitude stability of the frequency-converted phase-modulated signal may be degraded. There remains a need, therefore, for such sources to be optimized for use in systems where the generated light undergoes further transformation such as frequency conversion, spectral filtering and amplification in a solid-state amplifier or the like.

In view of these examples, there is therefore a need for methods and systems benefiting from the advantages of phase variation while alleviating at least some of its drawbacks.

### SUMMARY OF THE INVENTION

In accordance with an aspect of the present invention, there is provided a pulsed fiber laser oscillator including a light generating module generating optical pulses. Each optical pulse has an initial spectral profile and a pulse duration. The laser oscillator further includes a spectrum tailoring module for tailoring the initial spectral profile of the optical pulses to obtain a tailored spectral profile thereof. The tailored spectral profile defines a peak spectral density and a spectral width of the optical pulses. The spectrum tailoring module imposes a phase variation on each of the optical pulses according to an optimized phase varying function. The optimized phase varying function has one of a rectified sinusoidal shape, a parabolic shape and a rectified parabolic shape.

In accordance with another aspect of the invention, there is provided a laser system including a pulsed fiber laser oscillator. The pulse fiber laser oscillator includes a light generating module generating optical pulses, each optical pulse having an initial spectral profile and a pulse duration. The pulsed fiber laser oscillator further includes a spectrum tailoring module for tailoring the initial spectral profile of the optical pulses to obtain a tailored spectral profile thereof. The tailored spectral profile defines a peak spectral density and a spectral width. The spectrum tailoring module imposes a phase variation on each of the optical pulses according to an optimized phase varying function. The optimized phase varying function has one of a rectified sinusoidal shape, a parabolic shape and a rectified parabolic shape. The laser system further includes a fiber power amplifier module provided downstream the laser oscillator, for amplifying said optical pulses.

Other features and advantages of the present invention will be better understood upon a reading of preferred embodiments thereof with reference to the appended drawings.

### BRIEF DESCRIPTION OF THE DRAWINGS

FIG. 1 schematically illustrates a pulsed fiber laser oscillator according to an embodiment of the invention.

FIGS. 2A and 2B show periodic phase varying functions respectively having sinusoidal and parabolic shapes (FIG. 2A) as well as rectified sinusoidal and parabolic shapes (FIG. 2B).

FIGS. 3A to 3D (PRIOR ART) are graphs showing the output spectra obtained by phase modulating a narrow linewidth source with a sinusoidal function for different is peak phase variation values.

FIG. 4 is a graphical representation of the RMS width of the phase carried signal as a function of the Brillouin gain reduction factor, K.

FIG. 5 is a graph showing the sinusoidal and rectified parabolic phase varying functions applied to the phase modulator for a K factor of 18.6.

FIG. 6 is a graph showing the peak spectral density distribution among the sidebands for the sinusoidal and rectified parabolic phase varying functions of FIG. 5.

FIG. 7A is a schematic representation of a laser system according to an embodiment of the invention, including a nonlinear crystal for harmonic frequency conversion; FIG. 7B is a schematic representation of a laser system according to another embodiment of the invention, including a bulk solid-state amplifier.

FIG. 8 is a graph showing the spectral acceptance bandwidth for type I SHG in an 1 cm-long LBO crystal noncritically phase matched for 1.064 μm.

FIG. 9 is a graph showing the spectral acceptance dependence for type I SHG and type II THG in LBO crystals with a signal source at 1.064 μm.

FIG. 10 is a graph showing the spontaneous emission spectrum measured from a Nd:YVO₄ crystal superimposed with the seed signal narrow spectrum.

### DESCRIPTION OF PREFERRED EMBODIMENTS OF THE INVENTION

Embodiments of the present invention generally provide pulse generating methods, pulsed fiber laser oscillators and laser systems adapted for high power applications such as memory repair, milling, micro-fabrication, drilling and other material processing applications. In some embodiments, such laser systems may be particularly useful where spectral filtering, frequency conversion and/or amplification of the output beam is desired. It will however be understood that embodiments of the present invention may also be used in other contexts such as remote sensing or any other application which may benefit from high power pulses having good optical characteristics.

### Pulsed Fiber Laser Oscillator

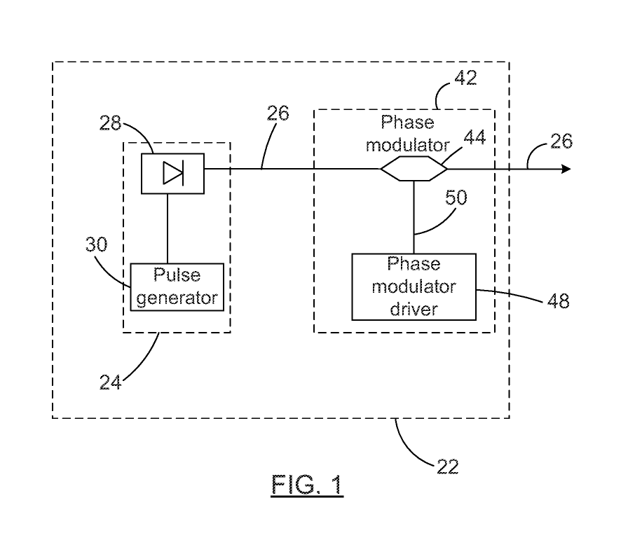

Referring to FIG. 1, there is shown a pulsed fiber laser oscillator 22 according to one embodiment of the invention.

The expression “oscillator” is understood to refer to the portion of a laser system that generates optical pulses. The expression “optical pulses” or “light pulses” is understood herein to refer to the discrete onset of electromagnetic radiation separated by an interpulse period where light is absent or negligible. The oscillator may include a laser cavity or alternatively be based on fluorescent emissions. The laser oscillators according to embodiments of the present invention are preferably fiber-based, which is understood to mean that light circulating in the oscillator is generally guided by optical fiber. It is however not excluded from the scope of the invention that the oscillator may include components external to optical fibers, and some of the embodiments described below indeed include such components. In addition, the components of the laser oscillator may be embodied in more than one length of optical fiber, coupled together through known techniques such as fiber pigtails, fusion-spliced coupling, mechanical couplers and the like.

The optical fiber or fibers embodying components of the laser oscillator may have any appropriate structure. Depending on its function the optical fiber may be single mode or multimode, with a single or multiple cladding. It may be embodied by a standard fiber, a polarisation maintaining (PM) fiber, a microstructured (or “holey”) fiber or any other appropriate specialized type of fiber or light guiding structure. It may be made of any suitable materials such as pure silica, doped silica, composite glasses or sapphire.

The laser oscillator 22 first includes a light generating module 24 generating optical pulses 26. Each optical pulse 26 has optical characteristics including its spectral profile, pulse duration, repetition rate and temporal intensity profile.

The intensity of light in a given pulse as a function of time over its duration is herein referred to as the temporal intensity profile or temporal profile. The term “pulse duration” generally refers to the period of time between the beginning and the end of an individual pulse. Several conventions can be used to determine the moment at which a light pulse begins and ends, as will be readily understood by one skilled in the art. For example, it can be determined accordingly to a given fraction, such as 50% or 1/e² or any other fraction, of the maximum intensity of the temporal profile of the pulse. In other variants, the pulse duration could be based on the Root-Mean-Square (RMS) intensity of a complex temporal profile. There are multiple possible definitions of the pulse duration and one skilled in the art will readily understand that any such convention can be used without departing from the scope of the present invention.

In embodiments of the invention described herein, measured pulse durations can be is of the order of nanoseconds or picoseconds, for example. One skilled in the art will however understand than longer or shorter pulses could alternatively be used depending on the requirements of a particular application.

The expression “spectral profile” as used herein is understood to refer to the intensity distribution of light at a particular moment as a function of wavelength. The spectral profile of the light pulses as outputted by the light generating module 24 is referred to herein as the initial spectral profile. Preferably, the initial spectral profile can be considered stable at least throughout the pulse duration. In a preferred embodiment, the initial spectral profile is embodied by a single discrete line, having as narrow a linewidth as possible for a given configuration of the light generating module 24. Alternatively, the initial spectral profile may include a few or several discrete spectral lines of similar or different intensities. It may alternatively take the form of a continuous wavelength distribution, which may be simply shaped or more complex.

The light generating module 24 may include any device or assembly of devices and components apt to generate optical pulses 26 having the required optical characteristics for a target application. For example, in the illustrated embodiment of FIG. 1 the light generating module 24 includes a pulsed light source 28 driven by an appropriate pulse generator 30. The pulse light source 28 may for example be a semiconductor laser diode of any appropriate configuration such as a Fabry-Perot cavity, a distributed-feedback diode laser, an external-cavity diode laser (ECDL), etc. The semiconductor diode laser output may be fiber-coupled and emitted light may thus be guided in a single transverse mode within the optical fiber core. The pulse generator 30 may for example be embodied by a device or platform apt to generate a pulse drive signal of appropriate characteristics, and is preferably based on high speed electronics. One skilled in the art will readily understand that the optical characteristics of the optical pulses 26 will depend on a number of factors such as the complex impedance of the pulsed light source 28, which is itself dependent on the is physics of the cavity of this source and on the laser diode package.

In alternative embodiments, the light generating module may include a continuous light source generating a continuous light beam, followed by external amplitude modulators modulating the continuous light beam to provide the optical pulses. In such embodiments, the pulse generator sends drive signals to the amplitude modulators in complete or partial synchronization so that light allowed through the modulator chain defines the optical pulses.

It will be noted that either type of light source, whether pulsed or continuous, may be tunable in wavelength, according to techniques known in the art. Alternatively, external spectral tuning components such as filters, gratings or the like (not shown) may be provided externally to the light source.

Additional optical components may be provided in the light generating module 24, such as lenses, mirrors, gratings, polarization controllers or any other components directing or modifying the travelling light in an appropriate fashion.

The laser oscillator 22 further includes a spectrum tailoring module (STM) 42 for tailoring the initial spectral profile of the optical pulses 26 to obtain a tailored spectral profile thereof. A phase modulator 44 is preferably provided in order to impose a phase variation on each optical pulse 26. The phase modulator 44 may be embodied by an electro-optic component based modulator such as well known in the art. The electro-optical material included in the phase modulator can be LiNbO₃, LiTaO₃, KNbO₃ or any other appropriate nonlinear material. Alternatively, the phase modulator may be based on an acousto-optic component such as an acousto-optic modulator. In some embodiments, more than one phase modulator may be provided in cascade, each applying a phase variation to the optical pulses therethrough so that their is combined effect on the phase of the optical pulses results in the desired tailoring of their spectral profile. Alternatively or additionally, the spectral tailoring module 42 may be configured so that the optical pulses make more than one pass through one or more phase modulators.

The phase modulator 44 imposes a phase variation on each optical pulse 26 therethrough according to an optimized phase varying function, as will be explained further below. In the illustrated embodiment, a phase modulator driver 48 drives the activation of the phase modulator 44 through a phase varying drive signal 50 providing the desired variation.

It will be readily understood that the phase modulator need not be in constant operation in order to apply the phase varying function to the optical pulses therethrough. Optionally, in one embodiment, the phase modulator may be activated in synchronization with the arrival of optical pulses thereat, as taught in U.S. patent application published under no. 2010/0128744 by DELADURANTAYE et al. Advantageously, such a “synchronously gated phase variation” scheme considerably reduces the RF average power level required for efficiently tailoring the pulse spectral profile, as the phase modulation is active for only a small fraction of the time.

### Spectrum Tailoring Through Phase Variation

In order to explain the principles behind the spectrum tailoring capability provided by phase variation in the context of pulsed fiber laser sources, the simple case of a sinusoidal, single-frequency (Ω) phase variation is first presented. The case where each optical pulse has an initial spectral profile centered at an optical frequency ν with a linewidth Δν will be considered.

In general, the electric field amplitude time dependence of the optical pulses is given by:

E(t)=E₀ sin(2πν×t+φ(t) (1)

where φ(t) is the time-dependent phase term that varies when applying the phase variation. In the single frequency example, this term has the profile:

$$φ ( t ) = \frac{{φ}_{peak}}{2} sin ( 2 π Ω \times t + {φ}_{0} ) \qquad ( 2 )$$

where φ₀ is the initial phase and φₚₑₐₖ the peak phase deviation. The peak phase deviation obtained when applying a peak voltage Vₚₑₐₖ on the phase modulator is given by:

$${φ}_{peak} = π \times \frac{{V}_{peak}}{{V}_{π}} \qquad ( 3 )$$

where V_{π} is a characteristic of the phase modulator. The Fourier decomposition of E(t) with φ(t) given by equation (2) is a well known result of applied mathematics (see for example Bruce Carlson, “Communication systems—An introduction to Signals and Noise in Electrical Communication”, McGraw-Hill, New York, 1986, chapter 7). In principle, under adequate phase variation conditions, an infinite number of sideband lines at optical frequencies ν±nΩ, where n is an integer, appear in the spectral profile of the optical pulses. The spectral power density associated with a side band of index n depends on the value of φₚₑₐₖ. In general, for n>φₚₑₐₖ, the spectral power density decreases rapidly with n.

Hence, the application of a sinusoidal phase variation having a single frequency adds spectral components to the initial spectral profile of the pulse under certain conditions specific to the characteristics of the pulse and of the phase variation, thereby broadening the pulse spectral profile.

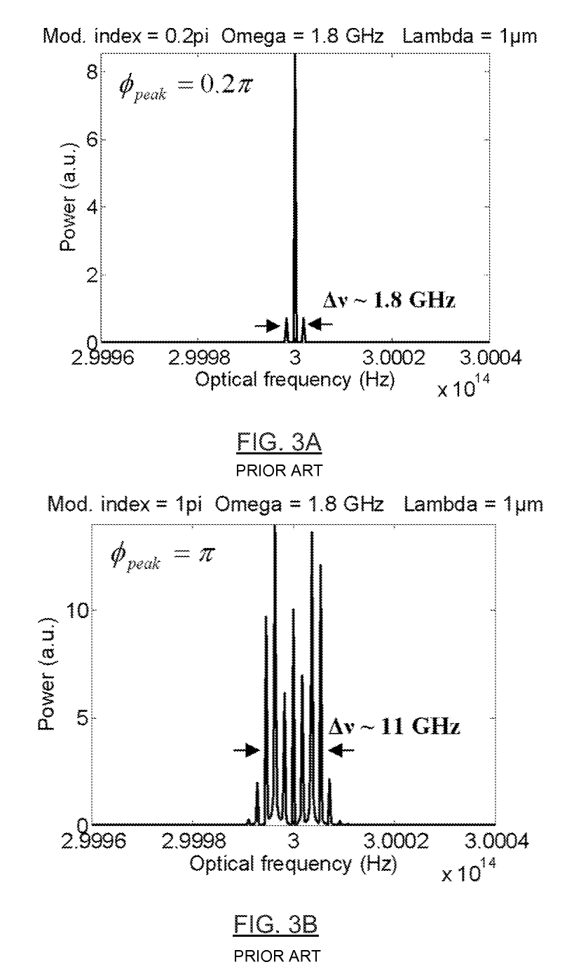

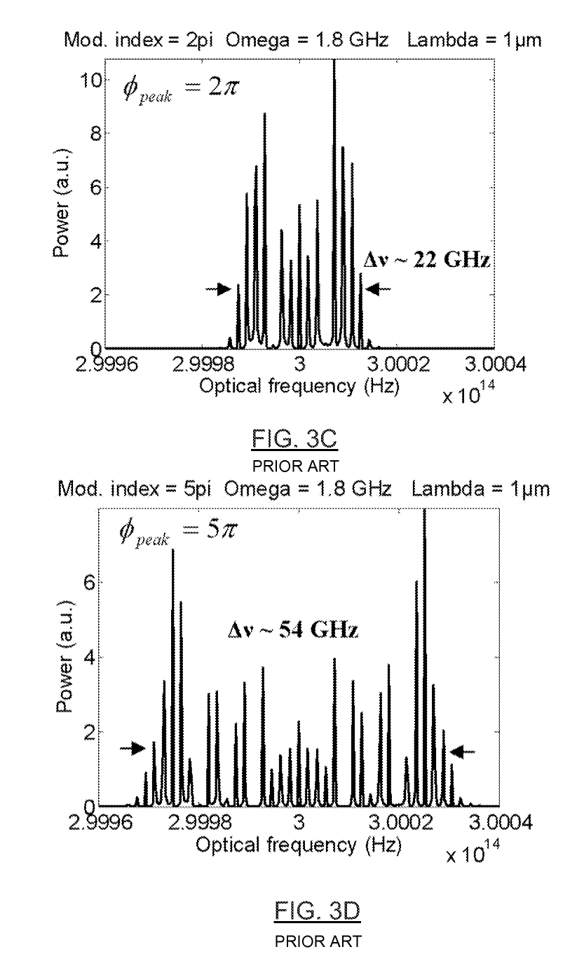

FIGS. 3A to 3D illustrate typical spectra obtained after imposing a sinusoidal phase variation as a function of the total phase shift φₚₑₐₖ produced in the phase modulator. These graphs were simulated using, for illustrative purposes, optical pulses prior to phase modulation having a pulse duration of 10 ns, a square pulse shape with a 10-90% risetime of 1.5 ns, a pulse repetition rate of 100 kHz and an emission wavelength of 1064.5 nm. The phase variation fundamental frequency was set to 1.8 GHz and the optical pulse and the phase varying function were not in-phase.

The intensity of each sideband is given by

$${{J}_{n} ( \frac{{φ}_{peak}}{2} )}^{2} \qquad ( 4 )$$

where n is the sideband order and φₚₑₐₖ is the maximum phase shift (peak to peak) produced in the phase modulator. One can clearly see that the outer sidebands are the most intense. As such, they will be the ones determining the new SBS threshold of the signal, which depends, as mentioned above, on the peak spectral density of the signal (i.e. the intensity of the most intense spectral line).

### Optimized Phase Varying Function

In accordance with one aspect of the invention, an optimized phase varying function is used to control the operation of the phase modulator 44 in order to improve the optical characteristics of the optical pulses outputted by the laser oscillator 22, particularly in view of the further modification of these pulses through spectral filtering, amplification, frequency conversion or the like.

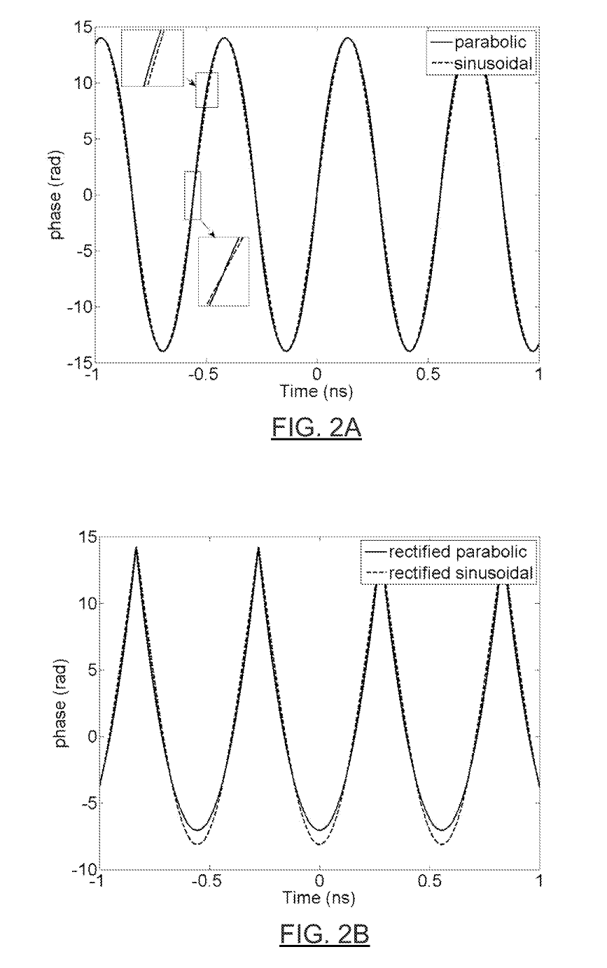

The inventors have identified three possible shapes for the phase varying function that provide an increase of the SBS threshold inside the fiber laser system, while maintaining appropriate spectral characteristics for subsequent amplification and/or frequency conversion: a rectified sinusoidal shape, a parabolic shape and a rectified parabolic shape. For instance, periodic phase varying functions having sinusoidal and parabolic shapes are shown in FIG. 2A whereas rectified sinusoidal and parabolic phase varying functions are shown in FIG. 2B.

Referring back to the illustrated embodiment of FIG. 1, the optimized phase varying function is applied to the optical pulses through the phase modulator 44 as controlled by the phase modulator drive signal 50. One skilled in the art will readily understand that the optimized phase varying function is therefore generated by the phase modulator driver 48 and carried by the phase modulator drive signal 50. One skilled in the art will also readily understand that the shape of the phase modulator drive signal can differ somewhat from a mathematical representation of a rectified sinusoidal, parabolic or rectified parabolic shape, inasmuch as the general behavior of this signal is close enough to the desired shape so as to be recognizable as such.

The phase modulator driver may be embodied by an analog function generator or a digital pattern generator, or any other device or combination of devices apt to generate a phase modulator drive signal having the desired shape.

The expression “rectified” is understood to refer to the concept of converting a periodic function which periodically reverses direction to the same variations in a single direction, by analogy to the transformation performed by a rectifier converting alternating current (AC) to direct current (DC). More information on rectified electrical signals, in the electrical engineering sense, as obtained through the use of a rectifier circuit can for example be found in Richard C. Dorf, “The electrical engineering handbook”, CRC Press, Boca Raton, 1993, chapter 5. A rectified function can for example be generated through one of the following techniques:
Appropriate programming of a wide bandwidth Arbitrary Waveform Generator (AWG). AWGs with a bandwidth of about 10 GHz are currently available on the market (see for example the Tektronik AWG7000B (trademark)).
Squaring of a saw-tooth signal by an electronic circuit with square law voltage transfer function (see for example U.S. Pat. No. 5,430,407).
Integrating the output of a ramp generator with an appropriate electronic circuit.
Summing the first few harmonics of the rectified parabolic or sinusoidal function with the appropriate relative amplitude and phase.

The optimized phase varying function preferably has parameters such as its frequency and peak phase deviation selected in view of desired optical characteristics of the outputted optical pulses.

Preferably, the timescale over which the phase is varied should be significantly shorter than the phonon lifetime associated with the glass matrix of the optical fiber considered for efficient SBS mitigation. The frequency of the optimized phase varying function is therefore preferably selected in view of this factor. For example, for a typical phonon lifetime of 16 ns, the phase of the optical pulses should be varied at a speed at least ten times faster, which gives a minimal modulating frequency of 625 MHz.

To minimize the pulse spectrum variations from pulse to pulse, the phase varying function preferably has a phase variation frequency providing several periods over the pulse duration, so that at least a few periods of phase variation are averaged over the timescale of the pulse duration. For example, for a pulse duration of 10 ns, the phase variation frequency is preferably at least 1 GHz.

The peak phase deviation of the phase varying function is preferably selected within a predetermined range determined by the desired compromise between the spectral density and the spectral width of the outputted optical pulses in view of the target application. The number of sidebands in the spectral profile of the light pulses depends directly on the peak phase variation (see for instance FIGS. 3A-D). The number of sidebands has a direct impact on the peak spectral density of the tailored spectral profile; more sidebands provide a more even distribution of spectral density between the sidebands, thus reducing the peak spectral density of the most intense sidebands. As it is often desirable to minimize the peak spectral density to mitigate SBS effects, the lower limit of the predetermined range for the peak phase deviation will often be dictated in view of a target value for the peak spectral density of the tailored spectral profile. Conversely, increasing the peak phase variation will broaden the spectral width of the output pulses accordingly, a factor that must be controlled, especially if the light pulses are to be subsequently frequency converted. The upper limit of the predetermined range for the peak phase deviation is therefore preferably determined in view of target value for the spectral width of the tailored spectral profile.

The impact of a selected phase variation function can be evaluated through the measure of the ratio of the peak spectral density of the signal before and after phase variation, which will be referred to herein as the factor K. The decrease of the Stimulated Brillouin Scattering gain experienced by the Stokes signal is directly proportional to that factor. In a first approximation, it can be said that the new SBS threshold will be K times the SBS threshold without phase variation. In systems where spectral filtering will be performed after amplification through the active fiber, one would favour the narrowest spectral content that would have a satisfactory K factor.

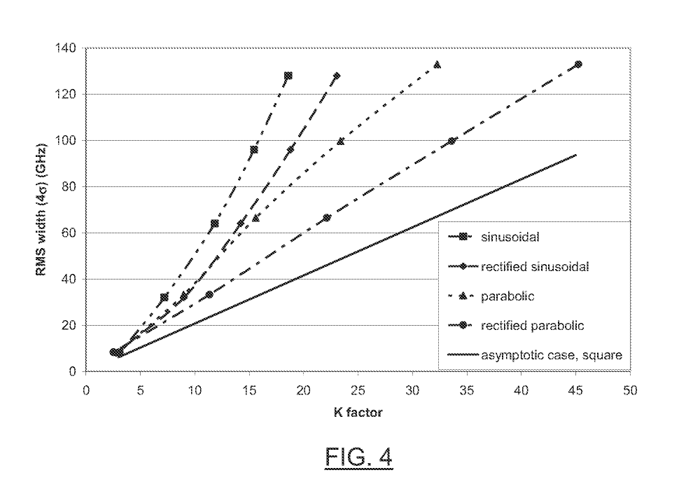

The RMS width (4σ) can be used to describe the spread of the spectral content of the optical pulses after the tailoring of their spectral profile. FIG. 4 represents this spectral width as a function of the K factor for sinusoidal, rectified sinusoidal, parabolic, rectified parabolic and asymptotic phase variations. The asymptotic case corresponds to sidebands of equal intensity. This case is not necessarily physical in the sense that it might not be possible to find the appropriate phase varying function to generate such a spectrum. As can be seen, the spectral width can advantageously be lowered for a same K factor using an optimized phase varying function in accordance with an embodiment of the invention, when compared with the simple sinusoidal case.

As mentioned above, in one embodiment of the invention, the optimized phase varying function has a rectified parabolic phase shape. A rectified parabolic phase varying function can be described as a succession of parabolas with the same curvature so as to form a periodic function with a nonzero mean value. The normalized Fourier series describing such a function is given by:

$${F}_{RP} ( t ) = S {\sum }_{n = 1}^{∞} \frac{8}{{π}^{2} {n}^{2}} cos ( 2 π nft ) \qquad ( 5 )$$

Where F_{RP} is the normalized rectified parabolic function and f its frequency. The constant S which can have a value of 1 or −1 describes the sign of curvature or its orientation.

The electronic components in the spectral tailoring module generally have limited bandwidths. As a consequence, the phase variation drive signal applied to the phase modulator will be a truncated version of equation (5), with attenuated high frequency components. Those truncated functions could be described by the following equation:

$${F}_{RP \_ TRUNC} ( t ) = S {\sum }_{n = 1}^{∞} \frac{8 Attn ( n )}{{π}^{2} {n}^{2}} cos ( 2 π nft ) \qquad ( 6 )$$

where Attn(n) is the attenuation coefficient for each spectral component.

Those skilled in the art will readily understand that such a bandwidth limited phase varying functions F_{RP}_{_{—}}_{TRUNC} can still be described as having a rectified parabolic shape.

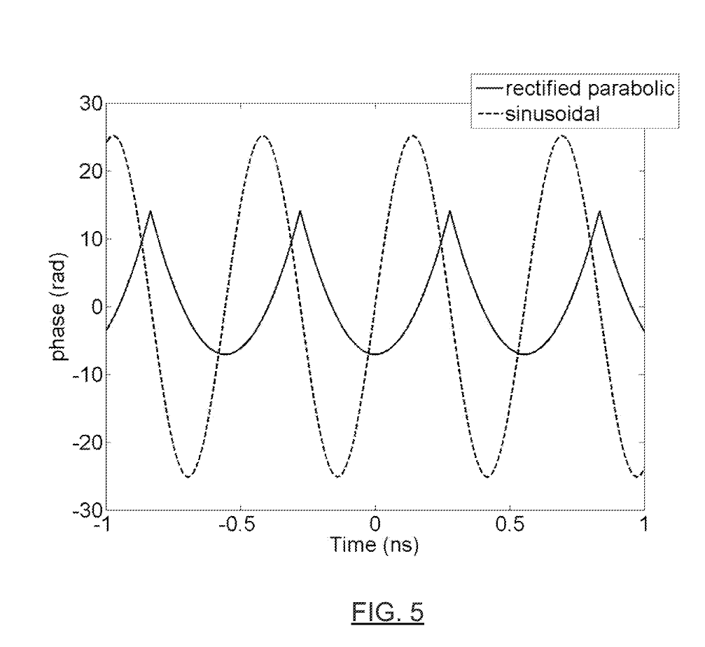

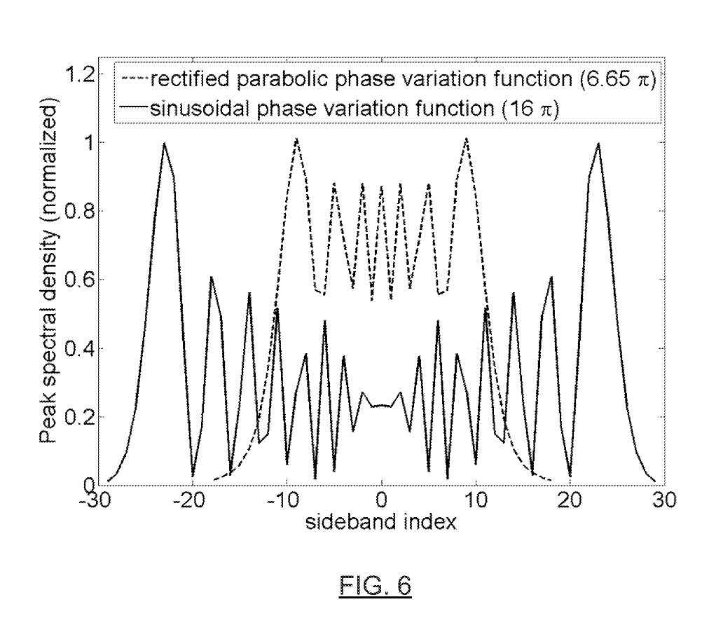

Referring to FIG. 5, an optimized phase varying function having a rectified parabolic shape for a K factor of 18.6 is shown. A sinusoidal function is also illustrated for comparison. FIG. 6 compares the distribution of the peak spectral density among the different sidebands, for a sinusoidal and a rectified parabolic phase varying function as shown in FIG. 5. One advantage associated with a rectified parabolic phase varying function over a sinusoidal phase varying function is the improved uniformity of the power distribution among the different sidebands which reduces the width of the spectral envelope. A reduction of the width of the spectral envelope translates directly in a decrease of amplitude noise when such a signal is amplified in a spectrally selective amplifier or frequency converted. Conversely, for equal Stimulated Brillouin Scattering gain reduction factors (K), the same rectified function can be used to greatly reduce the necessary total phase shift (6.65π instead of 16π), which reduces the stress on the components such as the phase modulator or RF amplifier. The reliability of such a system can thus be improved.

In accordance with another embodiment of the invention, the optimized phase varying function may be embodied by a periodic parabolic function. This function can be described by the following Fourier series:

$${F}_{P} ( t ) = {\sum }_{n = 1}^{∞} \frac{32 {( - 1 )}^{n}}{{{π}^{3} ( 2 n - 1 )}^{3}} cos ( 2 π ( 2 n - 1 ) ft ) \qquad ( 7 )$$

The same arguments concerning the bandwidth limitation of electronic components apply, consequently the truncated variations of equation (7) can still be described as a periodic parabolic function:

$${F}_{P \_ TRUNC} ( t ) = {\sum }_{n = 1}^{∞} \frac{32 {( - 1 )}^{n} Attn ( n )}{{{π}^{3} ( 2 n - 1 )}^{3}} cos ( 2 π ( 2 n - 1 ) ft ) \qquad ( 8 )$$

In accordance with another embodiment of the invention, the optimized phase varying function can have a rectified sinusoidal shape. Performing the same analysis as above this function can be described by the following Fourier series:

$${F}_{RS \_ TRUNC} ( t ) = S {\sum }_{n = 1}^{∞} \frac{8 Attn ( n )}{π ( 4 {n}^{2} - 1 )} cos ( 2 π nft ) \qquad ( 9 )$$

### Pulsed Fiber Laser System

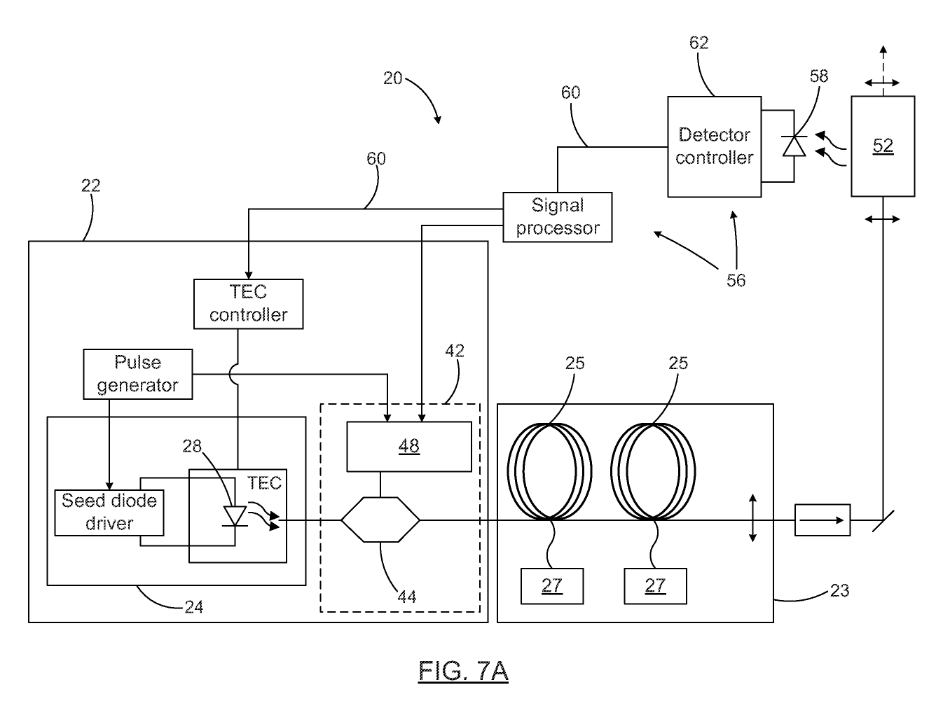

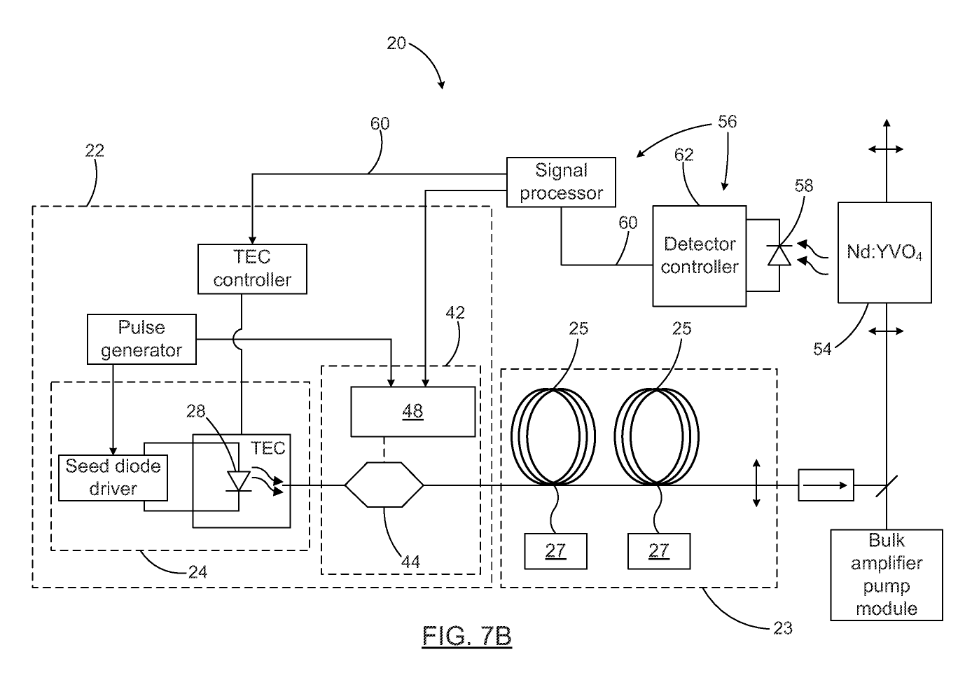

Referring to FIGS. 7A and 7B, there are illustrated fiber laser systems 20 in accordance with embodiments of the present invention.

The laser system 20 preferably has a Master Oscillator Power Amplifier (MOPA) architecture, including a Master Oscillator 22, preferably embodied by a fiber laser oscillator as described above, an a fiber Power Amplifier 23 provided downstream the laser oscillator for amplifying the optical pulses generated thereby.

The Power Amplifier 23 is preferably embodied by a plurality of rare-earth-doped fiber amplifiers 25, each coupled to an appropriate pump 27. Pump light may coupled into the rare-earth-doped fiber either through, bulk optics or using pump and signal fiber combiners. Though not shown, optical isolators may be inserted between successive rare-earth-doped fiber amplifiers in order to prevent backward-propagating amplified spontaneous emission from entering amplifier stages upstream.

Referring more specifically to FIG. 7A, in accordance with one embodiment of the invention, the laser system 20 may include a nonlinear crystal 52 provided downstream the fiber power amplifier 23. The nonlinear crystal 52 performs a frequency conversion of the optical pulses therethrough, for example second harmonic generation. The nonlinear crystal 52 may for instance be embodied by lithium triborate (LBO), a crystal commonly used for frequency doubling Nd:YAG lasers. It can also be embodied by other borate crystals such as beta barium borate (BBO) or caesium lithium borate (CLBO). As explained above, frequency conversion is a nonlinear process in which photons of a given energy (or wavelength) interact to generate new photons with different energies (or wavelength). The simplest and industrially very important frequency conversion process is second harmonic generation, in which two photons at the fundamental wavelength (1064 nm for example) interact in a nonlinear crystal and are converted to one photon at twice the energy (532 nm).

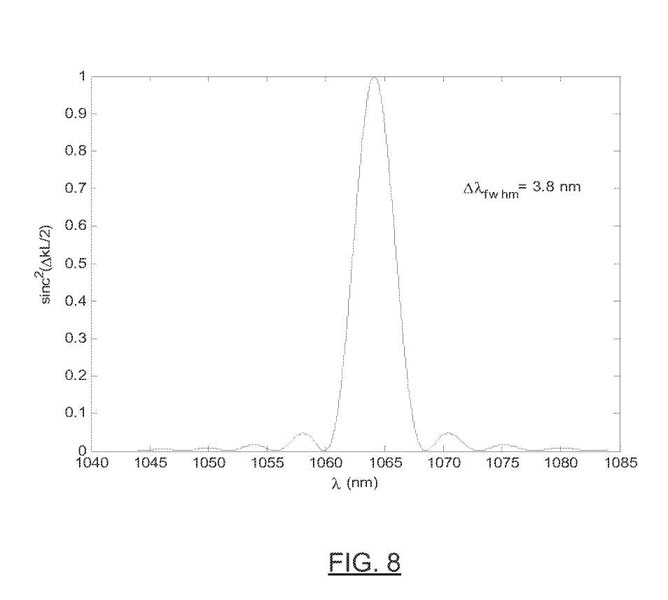

The peak phase deviation of the phase varying function is preferably selected so that the spectral width of the tailored spectral profile of the optical pulses falls within the spectral acceptance of the nonlinear crystal. Nonlinear processes in crystals are typically very sensitive to the spectral extent of the laser linewidth as shown in FIG. 8. The spectral acceptance bandwidth for second harmonic generation is a function of the nonlinear crystal length and fundamental wavelength, as can be computed from W. Koechner, “Solid-state laser engineering”, Springer-Verlag Berlin Heidelberg, fourth edition, 1996:

I_{2ω}=C²L²I_{ω}²{sin²(ΔkL/2)/(ΔkL/2)²} (10)

and

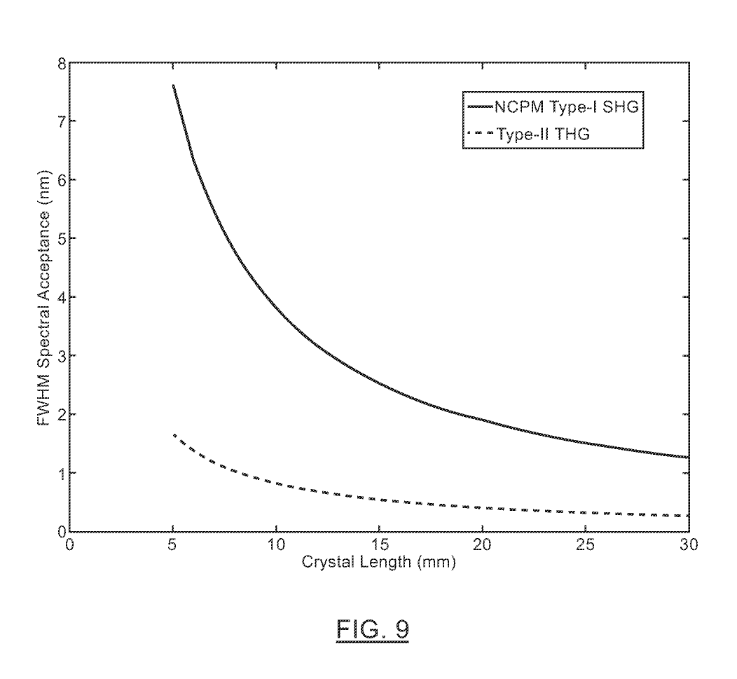

Δk=(4π/λ)(n_{ω}−n_{2ω}) (11)

where Δk is the phase mismatch term. The spectral acceptance bandwidth Δλ_{fwhm} is evaluated at 0.5 I_{2ω}, when equation (10) is computed as a function of variation in the fundamental wavelength λ. Those skilled in the art will recognize that this expression is generally valid in the condition that the fundamental beam is not depleted. Light pulses with a broad spectral content, that is, larger than the acceptance bandwidth of the crystal, will not be efficiently frequency converted. The spectral acceptance varies in inverse proportion to the crystal length; it is also dependent on the specific nonlinear process of interest. FIG. 9 illustrates this dependence for the second and third harmonic generation processes in LBO for a signal source at 1064 nm.

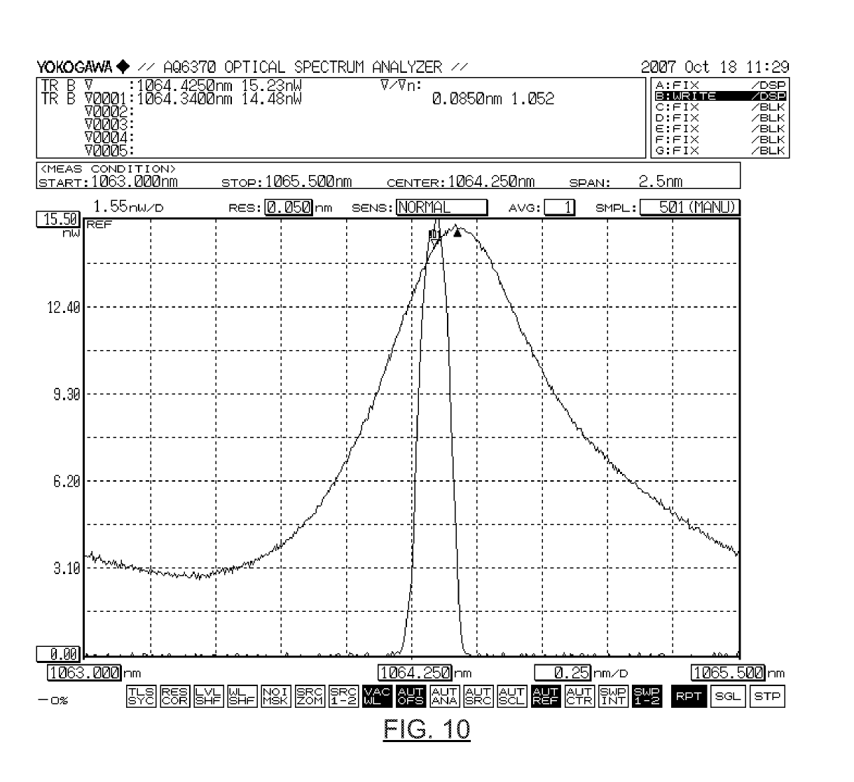

Referring now to FIG. 7B, the laser system 20 may alternatively or additionally include a bulk solid-state amplifier 54, provided downstream the fiber power amplifier 23 for further amplifying the optical pulses. The bulk solid-state amplifier 54 may for example be embodied by a neodymium-doped yttrium vanadate crystal (Nd:YVO₄). As mentioned above, solid-state gain media typically have narrow gain spectral bands. For example, as shown in FIG. 10, Nd:YVO₄ possesses a narrow gain band around 1064.5 nm (the latter shall be compared to the superimposed curve illustrating the even narrower linewidth that characterizes the emission coming out from the fiber laser oscillator without phase modulation).

Spectral matching of the pulses outputted by the MOFPA with the spectral characteristics of the subsequent device is highly desirable in several applications using pulsed fiber lasers incorporating further processing of the generated optical pulses, such as harmonic generation or power amplification in bulk solid-state amplifiers. The phase varying function applied to the optical pulses therefore preferably has a peak phase deviation selected so that the spectral width of the tailored spectral profile of the optical pulses falls within a gain spectral band of the bulk solid-state amplifier or within the spectral acceptance bandwidth of the nonlinear wave-mixing process. Then, it can provide for an optimizing of the characteristics of the output of the system and increase both the flexibility and stability of this output.

Referring back to both FIGS. 7A and 7B, the laser system 20 further preferably includes a feedback module 56. The feedback module 56 includes a detector 58 detecting the optical pulses, as outputted either by the laser oscillator 22, the power amplifier 23, or, if present, the bulk solid-state amplifier 54 or nonlinear crystal 52. More than one such detector 58 may be provided in a given laser system 20. The detector 58 and associated detector controller 62 generate a feedback signal 60 based on the detected optical pulses. For example, the feedback signal 60 may be embodied by an electrical signal proportional to the magnitude of the optical pulse. The detector 58 may be embodied by any appropriate device, such as biased PIN photodiodes. Alternatively, for the embodiment shown in FIG. 7B, measurement of the spontaneous fluorescence signal emitted by the bulk amplifier may be used instead of the optical pulse as the response measured by the proportional electrical signal.

The feedback module 56 further includes a tuning system receiving the feedback signal 60 and tuning the initial spectral profile of the optical pulses in view of this feedback signal 60. In one embodiment of the invention, a pulsed light source 28, having a center wavelength that is tunable in a controllable fashion, is used as part of the light generating module 24. As those skilled in the art will appreciate, this can for example be accomplished through temperature tuning of a laser diode embodying the pulsed light source 28.

Temperature tuning of the central emission wavelength of a semiconductor diode laser is inherently a slow process (hundreds of milliseconds). For high-speed adjustment of the center wavelength, the phase varying function could be optimized from pulse to pulse while the temperature of the seed laser diode is varied to maintain an appropriate spectral content. In the laser system of FIG. 7A or 7B, the feedback signal 60 from the bulk amplifier 54, the nonlinear crystal 52 or both is used to tune the center wavelength of the seed laser diode 28 by adjusting its temperature and/or by tailoring the phase varying function applied to the phase modulator 44. A simple way to offset the center wavelength of a seed laser diode through high-speed electronics and phase variation while the slow temperature tuning is in effect is to add a ramp signal to the phase varying function, and over time, reduce the slope of this ramp as the temperature tuning brings the center wavelength to the desired value.

Of course, numerous modifications could be made to the embodiments above without departing from the scope of the present invention.

1. A pulsed fiber laser oscillator, comprising:
a light generating module generating optical pulses, each optical pulse having an initial spectral profile and a pulse duration;
a spectrum tailoring module for tailoring the initial spectral profile of the optical pulses to obtain a tailored spectral profile thereof, the tailored spectral profile defining a peak spectral density and a spectral width, the spectrum tailoring module imposing a phase variation on each of said optical pulses according to an optimized phase varying function, said optimized phase varying function having one of a rectified sinusoidal shape, a parabolic shape and a rectified parabolic shape.

2. The pulsed fiber laser oscillator according to claim 1, wherein the phase varying function has a phase variation frequency providing several periods of said phase varying function over the pulse duration.

3. The pulsed fiber laser oscillator according to claim 1, wherein the phase varying function has a peak phase deviation selected within a predetermined range, said predetermined range having:
a lower limit determined in view of a target value for the peak spectral density of said tailored spectral profile; and
an upper limit determined in view of a target value for the spectral width of said tailored spectral profile.

4. The pulsed fiber laser according to claim 1, wherein the spectrum tailoring module comprises:
a phase modulator receiving the optical pulses therethrough and imposing the phase variation thereon; and
a phase modulator driver generating a phase modulator driver signal, said phase modulator driver signal controlling the phase modulator according to the optimized phase varying function.

5. A laser system comprising a pulsed fiber laser oscillator comprising:
a light generating module generating optical pulses, each optical pulse having an initial spectral profile and a pulse duration; and
a spectrum tailoring module for tailoring the initial spectral profile of the optical pulses to obtain a tailored spectral profile thereof, the tailored spectral profile defining a peak spectral density and a spectral width, the spectrum tailoring module imposing a phase variation on each of said optical pulses according to an optimized phase varying function, said optimized phase varying function having one of a rectified sinusoidal shape, a parabolic shape and a rectified parabolic shape.

6. The laser system according to claim 5, wherein the phase varying function has a phase variation frequency providing several periods of said phase varying function over the pulse duration.

7. The laser system according to claim 5, wherein the phase varying function has a peak phase deviation selected within a predetermined range, said predetermined range having:
a lower limit determined in view of a target value for the peak spectral density of said tailored spectral profile; and
an upper limit determined in view of a target value for the spectral width of said tailored spectral profile.

8. The laser system according to claim 5, wherein the spectrum tailoring module comprises:
a phase modulator receiving the optical pulses therethrough and imposing the phase variation thereon; and
a phase modulator driver generating a phase modulator driver signal, said phase modulator driver signal controlling the phase modulator according to the optimized phase varying function.

9. The laser system according to claim 5, further comprising a fiber power amplifier module provided downstream said pulsed fiber laser oscillator for amplifying said optical pulses.

10. The laser system according to claim 9, wherein the fiber power amplifier module comprises a plurality of rare-earth-doped fiber amplifiers.

11. The laser system according to claim 5, further comprising a nonlinear crystal provided downstream the pulsed fiber laser oscillator, said nonlinear crystal performing a frequency conversion of said optical pulses.

12. The laser system according to claim 11, wherein said nonlinear crystal is one of a lithium triborate crystal, beta barium borate crystal or caesium lithium borate crystal.

13. The laser system according to claim 11, wherein the phase varying function has a peak phase deviation selected so that the spectral width of the tailored spectral profile of said optical pulses is within a spectral acceptance bandwidth of the nonlinear crystal.

14. The laser system according to claim 11, further comprising a fiber power amplifier module for amplifying said optical pulses provided between said pulsed fiber laser oscillator and said non-linear crystal.

15. The laser system according to claim 5, further comprising a bulk solid-state amplifier provided downstream the pulsed fiber laser oscillator for further amplifying said optical pulses.

16. The laser system according to claim 15, wherein the bulk solid-state amplifier comprises a Nd:YVO₄ crystal.

17. The laser system according to claim 15, further comprising a fiber power amplifier module for amplifying said optical pulses provided between said pulsed fiber laser oscillator and said bulk solid-state amplifier.

18. The laser system according to claim 15, wherein the phase varying function has a peak phase deviation selected so that the spectral width of the tailored spectral profile of said optical pulses falls within a gain spectral band of said bulk solid-state amplifier.

19. The laser system according to claim 5, further comprising a feedback module comprising:
a detector detecting said optical pulses and generating a feedback signal based thereon; and
a tuning system receiving said feedback signal and tuning the initial spectral profile of said optical pulses in view of said feedback signal.

20. The laser system according to claim 11, further comprising a feedback module comprising:
a detector detecting said optical pulses subsequently to the frequency conversion thereof by the nonlinear crystal and generating a feedback signal based thereon; and
a tuning system receiving said feedback signal and tuning the initial spectral profile of said optical pulses in view of said feedback signal.

21. The laser system according to claim 15, further comprising a feedback module comprising:
a detector detecting amplifier spontaneous fluorescence signal from the bulk solid-state amplifier and generating a feedback signal based thereon; and
a tuning system receiving said feedback signal and tuning the initial spectral profile of said optical pulses in view of said feedback signal.
